(19) United States
(12) Patent Application Publication
(10) Pub. No.: US 2010/0109578 A1
(43) Pub. Date: May 6, 2010

(54) MOTOR CONTROL DEVICE

(75) Inventors: Wen-Bin Tsai, Taipei City (TW); Yu-Neng Chou, Taipei City (TW)

Correspondence Address: BANNER & WITCOFF, LTD., 1100 13th STREET, N.W., SUITE 1200, WASHINGTON, DC, 20005-4051, US

(73) Assignee: PAN-WORLD CONTROL TECHNOLOGIES, INC., Sijhih City (TW)

(21) Appl. No.: 12/582,444

(22) Filed: Oct. 20, 2009

(30) Foreign Application Priority Data
Oct. 30, 2008 (TW) 097219391

(51) Int. Cl. H04Q 9/00; H02P 27/00; H05B 41/392; H02K 29/08

(52) U.S. Cl. 318/16; 318/400.3; 315/291; 318/400.38

(57) ABSTRACT

A motor control device for controlling rotation of a brushless DC motor of a ceiling fan includes a receiver unit that receives an input signal and outputs a command signal, a magnetic sensor unit for detecting a magnetic pole variation of the brushless DC motor so as to generate a position signal, a processing unit that is electrically connected to the receiver unit and the magnetic sensor unit and that generates a control signal, a motor drive unit that is electrically connected to the processing unit and the brushless DC motor and that generates a drive signal for driving the brushless DC motor, an AC to DC converter unit that rectifies and filters a grid power to generate a first DC power for the motor drive unit, and a DC to DC converter unit that is electrically connected to the aforementioned units and that generates a second DC power.

### CROSS-REFERENCE TO RELATED APPLICATION

This application claims priority of Taiwanese Application No. 097219391, filed on Oct. 30, 2008.

### BACKGROUND OF THE INVENTION

1. Field of the Invention

The present invention relates to a control device, more particularly to a motor control device for a ceiling fan.

2. Description of the Related Art

A conventional ceiling fan uses a motor control device to control a rotation speed of a motor in accordance with a received input signal. The motor rotates vanes such that wind can be generated. In order to improve rotation efficiency, a brushless DC (direct current) motor is now commonly utilized.

The conventional motor control device for a brushless DC motor receives a grid power, and then steps down, rectifies, and filters the grid power to generate a first DC power for driving the brushless DC motor. Then, the motor control device steps down the first DC power to generate a second DC power for supply to a signal processing unit.

However, the task of stepping down the grid power needs to be implemented by a step-down transformer. During the process of stepping down the grid power using the step-down transformer, power is consumed, which increases the overall power consumption of the motor control device. Moreover, use of the step-down transformer results in an increase in the cost for the motor control device.

### SUMMARY OF THE INVENTION

Therefore, the object of the present invention is to provide a motor control device for a ceiling fan, which can reduce power consumption and cost.

Accordingly, a motor control device of the present invention is adapted for controlling rotation of a brushless DC motor of a ceiling fan. The motor control device comprises a receiver unit, a magnetic sensor unit, a processing unit, a motor drive unit, an AC to DC converter unit, and a DC to DC converter unit. The receiver unit receives an input signal and outputs a command signal in accordance with the input signal. The magnetic sensor unit is adapted for detecting a magnetic pole variation of the brushless DC motor so as to generate a position signal. The processing unit is electrically connected to the receiver unit and the magnetic sensor unit, and generates a control signal in accordance with the command and position signals. The motor drive unit is electrically connected to the processing unit and the brushless DC motor, and generates a drive signal for driving the brushless DC motor in accordance with the control signal. The AC to DC converter unit includes a rectifier and a filter. The rectifier receives and rectifies a grid power, and generates a rectified power from the grid power. The filter is electrically connected to the rectifier and the motor drive unit, and filters the rectified power to generate a first DC power for supply to the motor drive unit. The DC to DC converter unit is electrically connected to the receiver unit, the magnetic sensor unit, the processing unit, the motor drive unit, and the AC to DC converter unit, and steps down the first DC power to generate a second DC power for supply to the receiver unit, the magnetic sensor unit, the processing unit, and the motor drive unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view to illustrate a motor control device according to a preferred embodiment of the present invention in a state disposed in a ceiling fan;

FIG. 2 is a schematic circuit block diagram of the preferred embodiment of the motor control device according to the present invention;

FIG. 3 is a schematic diagram, illustrating the layout of the motor control device of the preferred embodiment on a first surface of a circuit board; and

FIG. 4 is a schematic diagram, illustrating the layout of the motor control device of the preferred embodiment on a second surface of the circuit board.

### DETAILED DESCRIPTION OF THE PREFERRED EMBODIMENT

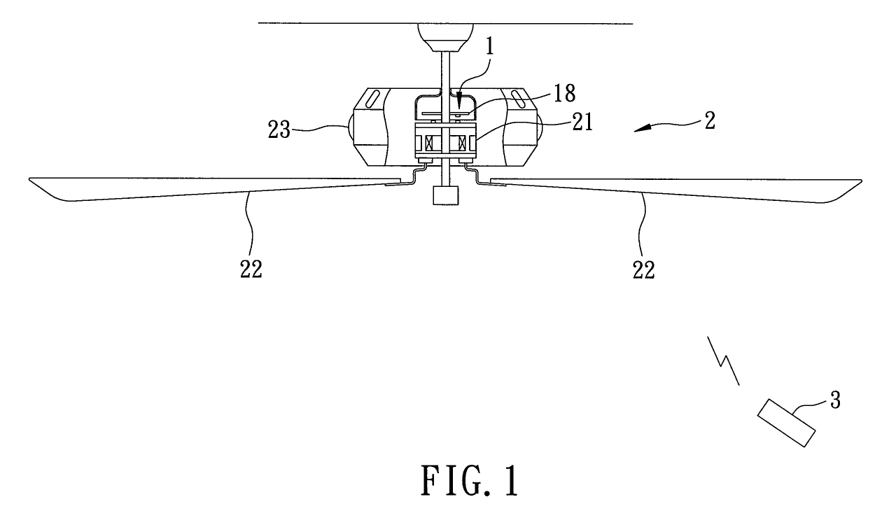

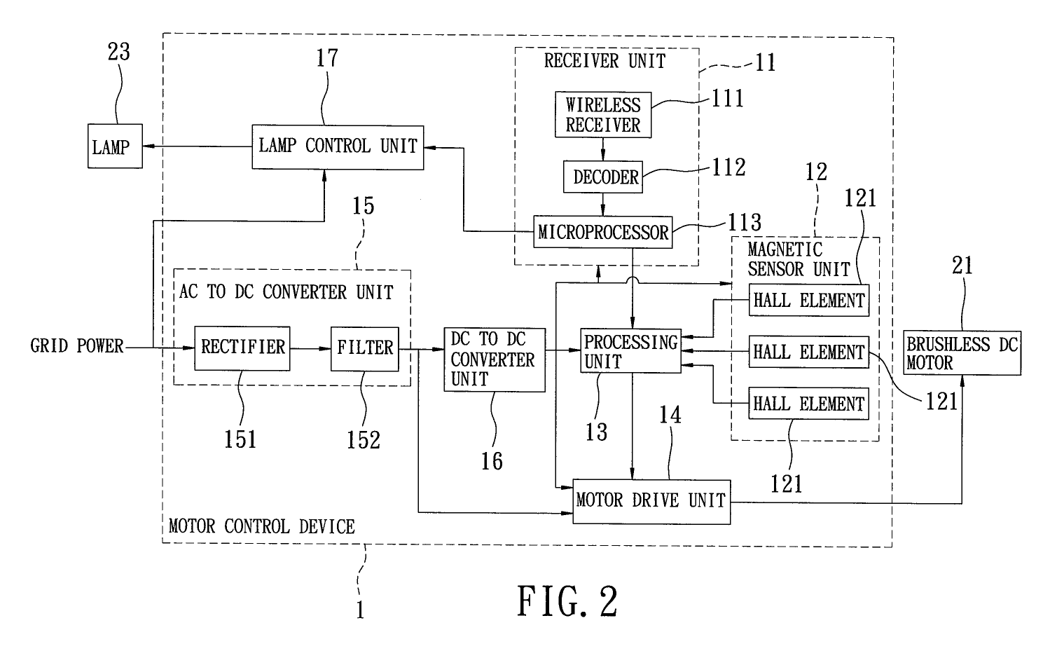

Referring to FIGS. 1 and 2, a preferred embodiment of a motor control device 1 of the present invention is adapted for controlling rotation of a brushless DC motor 21 of a ceiling fan 2. The motor control device 1 includes a receiver unit 11, a magnetic sensor unit 12, a processing unit 13, a motor drive unit 14, an AC to DC converter unit 15, a DC to DC converter unit 16, and a lamp control unit 17. The ceiling fan 2 includes a brushless DC motor 21, a plurality of vanes 22, and a lamp 23.

The receiver unit 11 receives an input signal and outputs a command signal in accordance with the input signal, and includes a wireless receiver 111, a decoder 112 electrically connected to the wireless receiver 111, and a microprocessor 113 electrically connected to the decoder 112. The wireless receiver 111 receives the input signal wirelessly from a remote control 3. The decoder 112 decodes the input signal received by the wireless receiver 111 to generate a decoded signal. The microprocessor 113 generates the command signal and a lamp control signal in accordance with the decoded signal, and adjusts a voltage of the command signal and a frequency of the lamp control signal in accordance with the decoded signal.

The magnetic sensor unit 12 is adapted for detecting a magnetic pole variation of the brushless DC motor 21 so as to generate a position signal, and includes a plurality of Hall elements 121 for detecting the magnetic pole variation of the brushless DC motor 21 so as to generate the position signal. In this embodiment, the magnetic sensor unit 12 includes three Hall elements 121. As an example, the Hall element(s) may be a Hall effect sensor.

The processing unit 13 is electrically connected to the receiver unit 11 and the magnetic sensor unit 12, and generates a control signal in accordance with the command and position signals. The processing unit 13 generates the control signal utilizing pulse-width modulation techniques.

The motor drive unit 14 is electrically connected to the processing unit 13 and the brushless DC motor 21, and generates a drive signal for driving the brushless DC motor 21 in accordance with the control signal. The motor drive unit 14 utilizes the drive signal to control rotation of the brushless DC motor 21 so as to initiate and maintain a rotation speed of the brushless DC motor 21 corresponding to the command signal.

The AC to DC converter unit 15 includes a rectifier 151 and a filter 152. The rectifier 151 receives and rectifies a grid power, and generates a rectified power from the grid power. The filter 152 is electrically connected to the rectifier 151 and the motor drive unit 14, and filters the rectified power to generate a first DC power for supply to the motor drive unit 14. In this embodiment, the rectifier 151 includes a full-wave bridge rectifier, and the filter 151 includes a capacitor.

The DC to DC converter unit 16 is electrically connected to the receiver unit 11, the magnetic sensor unit 12, the processing unit 13, the motor drive unit 14, and the AC to DC converter unit 15, and steps down the first DC power to generate a second DC power for supply to the receiver unit 11, the magnetic sensor unit 12, the processing unit 13, and the motor drive unit 14. In this embodiment, the DC to DC converter unit 16 includes a switching-mode power supply.

The lamp control unit 17 is electrically connected to the receiver unit 11 and the lamp 23, receives the grid power, and determines whether to supply the grid power to the lamp 23. If the lamp control unit 17 determines to supply the grid power to the lamp 23, the lamp control unit 17 further determines to supply an amount of the grid power to the lamp 23 in accordance with the lamp control signal to thereby control the brightness of the lamp 23. In this embodiment, the lamp control unit 17 includes a phototriac.

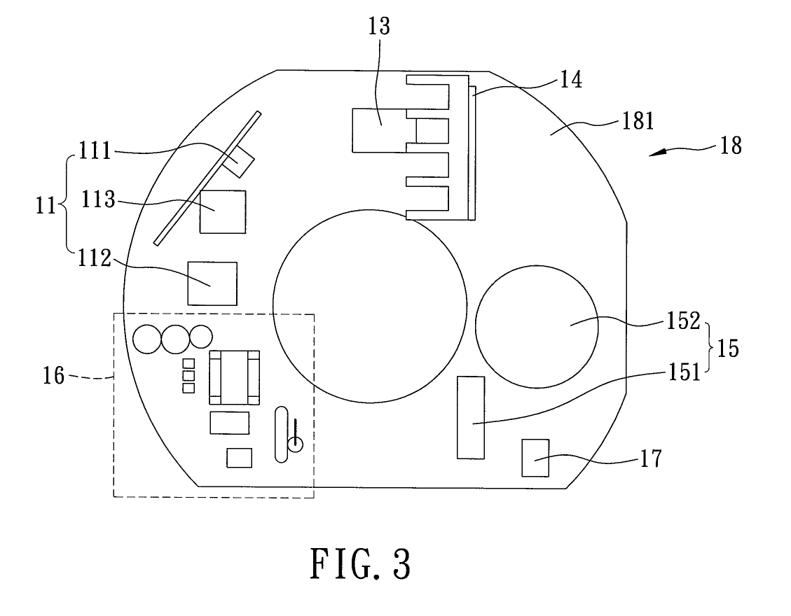

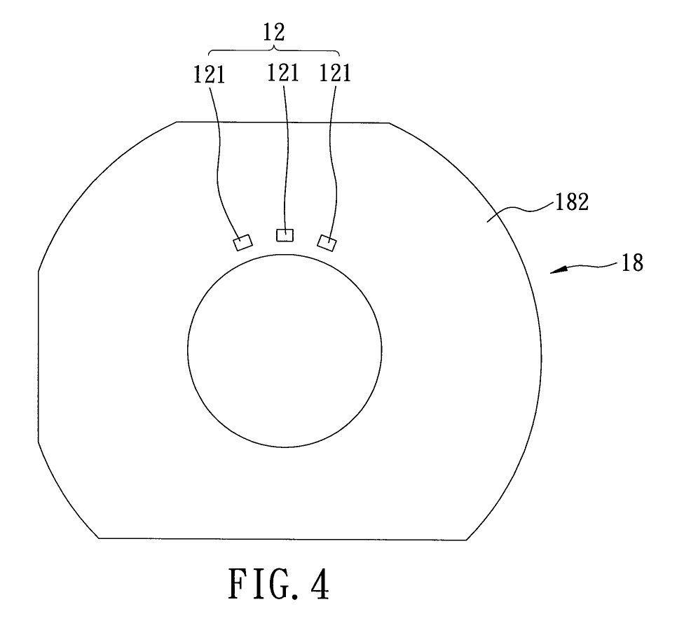

Referring to FIGS. 2, 3, and 4, the circuit board 18 includes a first surface 181 and a second surface 182 opposite to the first surface 181. In this embodiment, the receiver unit 11, the processing unit 13, the motor driver unit 14, the AC to DC converter unit 15, the DC to DC converter unit 16, and the lamp control unit 17 are disposed on the first surface 181. The Hall elements 121 of the magnetic sensor unit 12 are disposed on the second surface 182, which are angularly spaced apart from each other about a point that is roughly positioned in the center of the circuit board 18.

In this embodiment, the received grid power is rectified and filtered to generate the first DC power for supply to the brushless DC motor 21. During this process, the grid power is not stepped down so a step-down transformer is not required, which can reduce power consumption and cost.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A motor control device adapted for controlling rotation of a brushless DC motor of a ceiling fan, comprising:
a receiver unit that receives an input signal and outputs a command signal in accordance with the input signal;
a magnetic sensor unit adapted for detecting a magnetic pole variation of the brushless DC motor so as to generate a position signal;
a processing unit that is electrically connected to said receiver unit and said magnetic sensor unit, and that generates a control signal in accordance with the command and position signals;
a motor drive unit that is electrically connected to said processing unit and the brushless DC motor, and that generates a drive signal for driving the brushless DC motor in accordance with the control signal;
an AC to DC converter unit including
a rectifier that receives and rectifies a grid power, and generates a rectified power from the grid power, and
a filter that is electrically connected to said rectifier and said motor drive unit, and that filters the rectified power to generate a first DC power for supply to said motor drive unit; and
a DC to DC converter unit that is electrically connected to said receiver unit, said magnetic sensor unit, said processing unit, said motor drive unit, and said AC to DC converter unit, and that steps down the first DC power to generate a second DC power for supply to said receiver unit, said magnetic sensor unit, said processing unit, and said motor drive unit;
wherein said AC to DC converter unit does not include a transformer.

2. The motor control device as claimed in claim 1, wherein said receiver unit includes a wireless receiver, a decoder electrically connected to said wireless receiver, and a microprocessor electrically connected to said decoder, said wireless receiver receiving the input signal wirelessly, said decoder decoding the input signal received by said wireless receiver to generate a decoded signal, said microprocessor generating the command signal in accordance with the decoded signal.

3. The motor control device as claimed in claim 2, the ceiling fan including a lamp, wherein said motor control device further comprises a lamp control unit adapted for controlling brightness of the lamp, said microprocessor of said receiver unit generating a lamp control signal in accordance with the decoded signal, said lamp control unit being electrically connected to said receiver unit and the lamp, receiving the grid power, and determining whether to supply the grid power to the lamp in accordance with the lamp control signal.

4. The motor control device as claimed in claim 3, wherein said microprocessor of said receiver unit adjusts a frequency of the lamp control signal in accordance with the decoded signal, and said lamp control unit is adapted for supplying an amount of the grid power to the lamp in accordance with the lamp control signal.

5. The motor control device as claimed in claim 1, wherein said magnetic sensor unit includes a Hall element for detecting the magnetic pole variation of the brushless DC motor so as to generate the position signal.

6. The motor control device as claimed in claim 1, wherein said processing unit generates the control signal utilizing pulse-width modulation techniques.

7. The motor control device as claimed in claim 1, wherein said rectifier includes a full-wave bridge rectifier.

8. The motor control device as claimed in claim 1, wherein said filter includes a capacitor.

9. The motor control device as claimed in claim 1, further comprising a circuit board on which are disposed said receiver unit, said magnetic sensor unit, said processing unit, said motor driver unit, said AC to DC converter unit, and said DC to DC converter unit.
